(19) United States
(12) Patent Application Publication
(10) Pub. No.: US 2019/0294828 A1
(43) Pub. Date: Sep. 26, 2019

(54) MOBILE INFORMATION TERMINAL AND METHOD FOR CONTROLLING SAME

(71) Applicant: MAXELL, LTD., Kyoto (JP)

(72) Inventor: Kazuhiko YOSHIZAWA, Kyoto (JP)

(21) Appl. No.: 16/340,440

(22) PCT Filed: Feb. 9, 2017
(86) PCT No.: PCT/JP2017/004787

§ 371 Date: Apr. 9, 2019

(51) Int. Cl. G06F 21/83; G06F 21/40; G06F 21/32; H04M 1/673

(52) U.S. Cl. CPC G06F 21/83; H04M 1/673; G06F 21/32; G06F 21/40

(57) ABSTRACT

In order to improve an input operation function by effectively utilizing hardware resources in a mobile information terminal, a mobile information terminal (100) includes a first input section (123), a second input section (122) that is provided at a different location from the first input section, and a control section (101) that executes a single process using a first input signal inputted from the first input section and a second input signal inputted from the second input section.

### TECHNICAL FIELD

The present invention relates to a mobile information terminal and a method for controlling the same.

### BACKGROUND ART

A mobile information terminal such as a smart phone and a tablet terminal has become popular. As an example of an input section of such mobile information terminal, in Patent Literature 1, there is disclosed a configuration of “Tactile physical characteristic structures are formed in a bezel arranged around a touch screen of a tablet terminal. When the touch sensor detects a touch operation on one of the characteristic structures, a predefined input is enabled (excerpt of abstract)”.

### CITATION LIST

### Patent Literature

### Patent Literature 1: JP-A No. 2016-126363

### SUMMARY OF INVENTION

### Technical Problem

According to the tablet terminal of Patent Literature 1, the touch screen and the bezel are used independently. With respect to a mobile information terminal including a tablet terminal, from the viewpoint of securing portability, there is the limitation in the size of the case, the input section cannot be increased blindly, and therefore the actual circumstances are that the efforts for efficiently using the input sections of a limited number and further improving user-friendliness have been required.

The present invention has been achieved in view of the circumstances described above, and its object is to provide a technology for improving a function of the input operation by effectively utilizing hardware resources in a mobile information terminal.

### Solution to Problem

As a means for solving the problem described above, technologies described in claims are used.

As an example, a mobile information terminal is characterized to include a first input section, a second input section that is provided at a different location from the first input section, and a control section that executes a single process by using a first input signal inputted from the first input section and a second input signal inputted from the second input section.

### Advantageous Effects of Invention

By using the technology of the present invention, a technology for improving a function of the input operation by effectively utilizing hardware resources in a mobile information terminal can be provided. Also, problems, configurations, and effects other than those described above will be clarified by explanation of embodiments described below.

### BRIEF DESCRIPTION OF DRAWINGS

FIG. 1A is a hardware configuration diagram of a mobile information terminal of a first embodiment.

FIG. 1B is a front surface external view of the mobile information terminal of the first embodiment.

FIG. 1C is a back surface external view of the mobile information terminal of the first embodiment.

FIG. 1D is a software configuration diagram of the mobile information terminal of the first embodiment.

FIG. 2 is an operation state transition diagram of the mobile information terminal of the first embodiment.

FIG. 3A is a flowchart of a user authentication process of the mobile information terminal of the first embodiment.

FIG. 3B is a screen display drawing of a PIN input screen at the time of a user authentication process of the first embodiment.

FIG. 3C is a conceptual drawing of a PIN input operation at the time of the user authentication process of the first embodiment.

FIG. 4A is a flowchart of a user authentication process of the mobile information terminal of the first embodiment.

FIG. 4B is a screen display drawing of a PIN input screen at the time of the user authentication process of the first embodiment.

FIG. 4C is a conceptual drawing of a PIN input operation at the time of the user authentication process of the first embodiment.

FIG. 5A is a side surface external view of the mobile information terminal of the first embodiment.

FIG. 5B is a front surface external view of the mobile information terminal of the first embodiment.

FIG. 6A is a flowchart of a user authentication process of a mobile information terminal of a second embodiment.

FIG. 6B is a conceptual drawing of a PIN input operation at the time of a user authentication process of the second embodiment.

FIG. 6C is a conceptual drawing of a PIN input operation at the time of the user authentication process of the second embodiment.

FIG. 7A is a screen display drawing of a character input screen at the time of a character input process of a third embodiment.

FIG. 7B is a flowchart of a character input process of a mobile information terminal of the third embodiment.

FIG. 7C is a conceptual drawing of a character input operation at the time of a character input process of the third embodiment.

FIG. 7D is a conceptual drawing of a character input operation at the time of a character input process of the third embodiment.

FIG. 7E is a conceptual drawing of a character input operation at the time of a character input process of the third embodiment.

FIG. 8A is a hardware configuration diagram of a mobile information terminal of a fourth embodiment.

FIG. 8B is a front surface external view of a mobile information terminal of the fourth embodiment.

FIG. 8C is a side surface external view of the mobile information terminal of the fourth embodiment.

FIG. 8D is a system configuration diagram of a communication system including the mobile information terminal of the fourth embodiment.

FIG. 8E is a software configuration diagram of the mobile information terminal of the fourth embodiment.

FIG. 9A is a flowchart of a call process of a mobile information terminal of the fourth embodiment.

FIG. 9B is a flowchart of a call process of the mobile information terminal of the fourth embodiment.

FIG. 9C is a screen display drawing of a SIM selection screen at the time of initial setting of the fourth embodiment.

FIG. 9D is a screen display drawing of a basic screen of the fourth embodiment.

FIG. 9E is a screen display drawing of a call function screen of the fourth embodiment.

### DESCRIPTION OF EMBODIMENTS

Hereinafter, examples of embodiments of the present invention will be explained using the drawings.

### First Embodiment

The present embodiment relates to a mobile information terminal that executes a single process using input signals of two series from plural input sections (the first input section, the second input section) in an input operation of the mobile information terminal. As one of the merits of using input signals from plural input sections, such fact can be cited that validity or invalidity of acquisition of an input signal from the first input section is controlled by an input signal from the second input section in the first embodiment.

In general, a mobile information terminal can store plenty of personal information, and is also provided with functions of money transaction, various kinds of the settlement process, and the like. Therefore, when a mobile information terminal is used by a third party without any prior consent, damage of personal information leakage, monetary damage, and the like may possibly occur. In order to prevent the damage described above, a mobile information terminal is provided with a terminal lock function for restricting the function of the terminal and a user authentication function for authenticating a normal user who can set and reset the terminal lock function.

As a method for the user authentication process, a face authentication method, a fingerprint authentication method, a PIN (Personal Identification Number) input method, a password input method, a pattern input method, and so on are often employed. In comparing respective methods described above, the face authentication method and the fingerprint authentication method are superior in security, but cause a lot of authentication errors and authentication omissions, and require exclusive hardware and so on which is disadvantageous in cost. Meanwhile, the PIN input method, the password input method, and the pattern input method are easy-to-use, cause less authentication error and authentication omission, and do not require exclusive hardware and are advantageous in cost in a smart phone, a tablet terminal, and the like which are provided with a keyboard and a touch screen beforehand. However, by being peeped in inputting a PIN code, a password, and a pattern, there is a risk that such confidential information is known to a third party.

Therefore, in the first embodiment, by controlling validity or invalidity of the input operation of the first input section by the input signal of the second input section and executing a single process namely the PIN code input process for example, even when the input operation of the first input section may be peeped, the input process of the PIN code cannot be executed only by reproducing the input operation having been peeped, and improvement of the security is thereby sought for. Hereinafter, the first embodiment will be described in detail.

A mobile information terminal 100 according to the present embodiment is provided with a terminal lock function and a user authentication function, the terminal lock function being for properly restricting use of various kinds of the terminal function, the user authentication function being for authenticating a normal user who can set and reset the terminal lock function. The mobile information terminal 100 may be a cellular telephone, a smart phone, a tablet terminal, and the like. The mobile information terminal 100 may be also a PDA (Personal Digital Assistants), a notebook PC (Personal Computer), an electronic book reader, and the like. Also, the mobile information terminal 100 may be also a digital still camera, a video camera that can photograph a moving image, a portable game machine and the like, or other digital devices.

### Hardware Configuration Example of Mobile Information Terminal

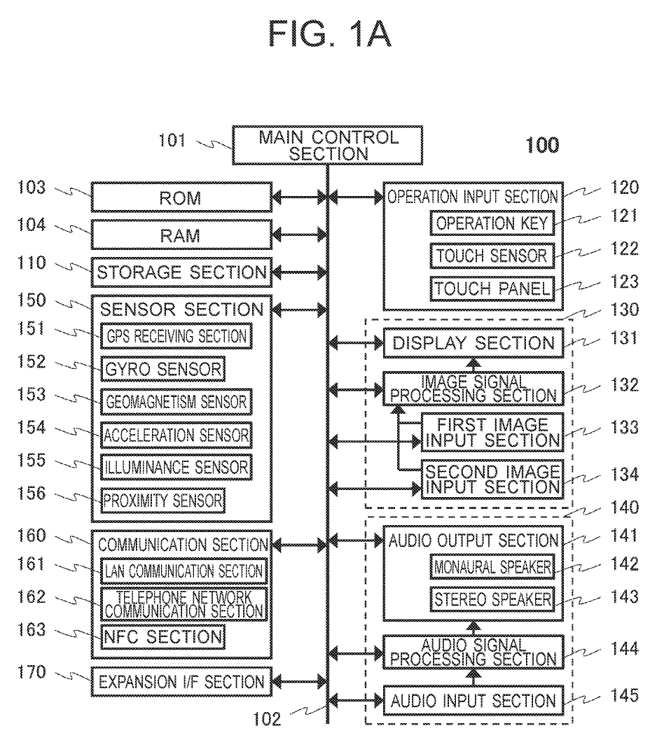

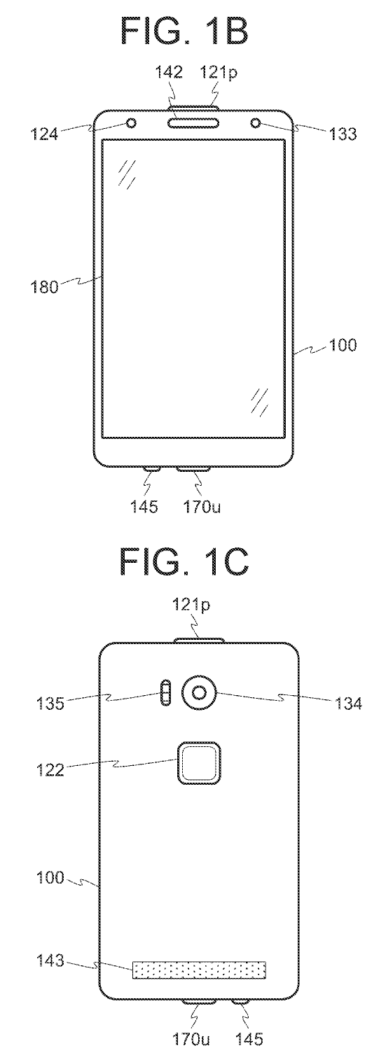

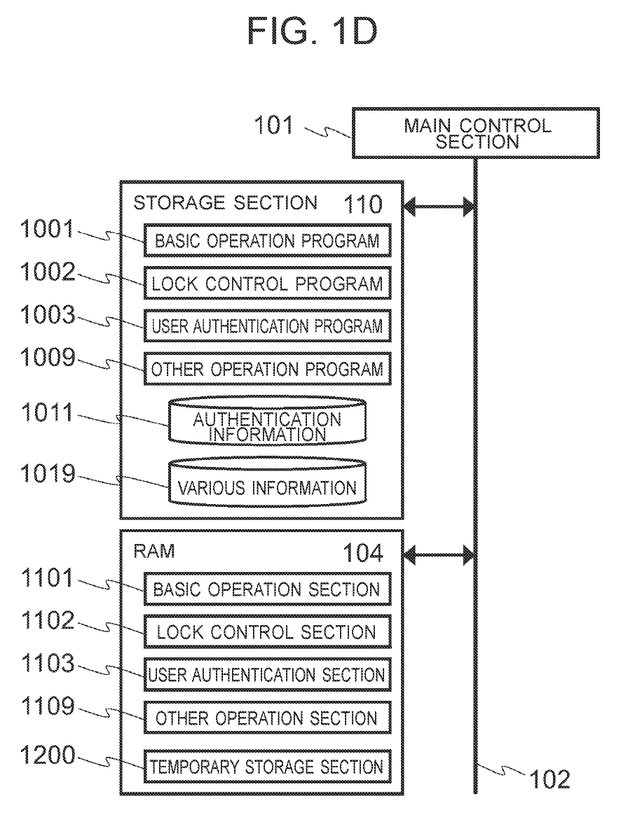

FIG. 1A is a hardware configuration diagram that shows an example of an internal configuration of the mobile information terminal 100. The mobile information terminal 100 is configured to include a main control section 101, a system bus 102, a ROM 103, a RAM 104, a storage section 110, an operation input section 120, an image processing section 130, an audio processing section 140, a sensor section 150, a communication section 160, and an expansion interface section 170.

The main control section 101 is a microprocessor unit that controls the entire mobile information terminal 100 according to a predetermined operation program. The system bus 102 is a data communication path for transmitting and receiving various kinds of commands and data between the main control section 101 and respective operation blocks within the mobile information terminal 100.

The ROM (Read Only Memory) 100 is a memory where a basic operation program of an operating system and the like and other operation program (application; will be the same hereinafter) are stored, and a rewritable ROM such as an EEPROM (Electrically Erasable Programmable ROM) and a flash ROM for example is used. The RAM (Random Access Memory) 104 becomes a work area at the time of executing a basic operation program and other operation programs. The ROM 103 and the RAM 104 may be configured integrally with the main control section 101. Also, with respect to the ROM 103, a partial storage region within the storage section 110 may be used instead of the independent configuration as shown in FIG. 1A.

The storage section 110 stores an operation program and an operation set value of the mobile information terminal 100 as well as the personal information, the authentication information, and the like of a user of the mobile information terminal 100. Also, the storage section 110 can store an operation program downloaded from a network and various kinds of data and the like generated by the operation program. Further, the storage section 110 can store contents such as a moving image, a stationary image, and an audio signal downloaded from a network. A partial region of the storage section 110 may be substituted for all or a part of the function of the ROM 103. Also, the storage section 110 is required to hold stored information even in a state where electricity is not supplied to the mobile information terminal 100 from the outside. Therefore, a semiconductor element memory such as a flash ROM and an SSD (Solid State Drive) and a device such as a magnetic disk drive such as an HDD (Hard Disk Drive) is used for example.

Also, respective operation programs described above stored in the ROM 103 and the storage section 110 can be updated or functionally expanded by a download process from respective server devices on the network.

The operation input section 120 is an instruction input section that inputs an operation instruction with respect to the mobile information terminal 100. The operation input section 120 is configured to include an operation key 121 where button switches and the like are arrayed, a touch sensor 122 that detects touch of the finger of a user based on change of the electrostatic capacitance, and a touch panel 123 that is disposed so as to be overlaid on a display section 131. The operation input section 120 may further include other operation devices. The mobile information terminal 100 may be operated using a keyboard and the like connected to the expansion interface section 170. The mobile information terminal 100 may be operated also using a separate mobile terminal device that is connected by wire communication or wireless communication.

The image processing section 130 is configured to include the display section 131, an image signal processing section 132, a first image input section 133, and a second image input section 134. The display section 131 is a display device of a liquid crystal panel and the like for example, and provides image data processed by the image signal processing section 132 to a user of the mobile information terminal 100. The image signal processing section 132 includes a video RAM whose illustration is omitted. The display section 131 is driven based on image data inputted to the video RAM. Also, the image signal processing section 132 has a function of executing a decoding process of a coded image signal, a format conversion process, a superposition process of a menu and other OSD (On Screen Display) signals, and so on according to the necessity. The first image input section 133 and the second image input section 134 are camera units that input image data of surroundings and objects by converting light inputted from a lens into an electric signal using an electronic device such as a CCD (Charge Coupled Device) and a CMOS (Complementary Metal Oxide Semiconductor) sensor.

The audio processing section 140 is configured to include an audio output section 141, an audio signal processing section 144, and an audio input section 145. The audio output section 141 is a speaker, and provides an audio signal processed by the audio signal processing section 144 to the user of the mobile information terminal 100. In particular, a monaural speaker 142 outputs a monaural audio at the time of the audio communication and the like, and a stereo speaker 143 outputs a stereo audio at the time of the music reproduction and the like. The audio signal processing section 144 has a function of executing a decoding process and the like of a coded audio signal according to the necessity. The audio input section 145 is a microphone, and converts the voice of the user and the like into audio data and inputs the same.

The sensor section 150 is a sensor group for detecting the state of the mobile information terminal 100. The sensor section 150 is configured to include a GPS (Global Positioning System) receiving section 151, a gyro sensor 152, a geomagnetism sensor 153, an acceleration sensor 154, an illuminance sensor 155, and a proximity sensor 156. By the sensor group of them, the position, inclination, orientation, and movement of the mobile information terminal 100, illuminance of surroundings, proximity state of the surrounding object, and so on can be detected. Also, the mobile information terminal 100 may further include other sensors such as an atmospheric pressure sensor.

The communication section 160 is configured to include a LAN (Local Area Network) communication section 161, a telephone network communication section 162, and an NFC (Near Field Communication) section 163. The LAN communication section 161 is connected to a network such as the internet through an access point and the like, and transmits and receives data to or from respective server devices on the network. Connection with the access point and the like described above may be executed by wireless communication such as Wi-Fi (registered trade mark). The telephone network communication section 162 executes telephone communication (telephone call) and transmission and receipt of data by wireless communication with a base station and the like of a mobile telephone communication network. Communication with the base station and the like may be executed by a W-CDMA (Wideband Code Division Multiple Access) (registered trade mark) method, an LTE (Long Term Evolution) method, and so on. The NFC section 163 executes wireless communication at the time of approaching a corresponding reader or writer. The LAN communication section 161, the telephone network communication section 162, and the NFC section 163 respectively include a coding circuit, a decoding circuit, an antenna, and the like. Also, the communication section 160 may further include another communication section such as a BlueTooth (registered trade mark) communication section and an infrared communication section.

The expansion interface section 170 is an interface group for expanding the function of the mobile information terminal 100. The expansion interface section 170 is configured to include at least one of an image interface and an audio interface (described as “image/audio interface” below), a USB (Universal Serial Bus) interface, a memory interface, and so on. The image interface executes inputting of an image signal from an external image output device and outputting of an image signal to an external image input device. The audio interface executes inputting of an audio signal from an external audio output device and outputting of an audio signal to an external audio input device. The USB interface is connected to a PC and the like, and transmits and receives data. Also, the USB interface may connect a keyboard and other USB devices. The memory interface connects a memory card and other memory media, and transmits and receives data.

Further, although the configuration example of the mobile information terminal 100 shown in FIG. 1A also includes many configurations not indispensable in the present embodiment, even a configuration not including them does not impair the effect of the present embodiment. Also, a configuration not illustrated such as a digital broadcasting receiving function and an electronic money settlement function may be further added.

### [External View Example of Mobile Information Terminal]

FIG. 1B is a front surface external view that shows an example of the external view of the mobile information terminal 100. FIG. 1C is a back surface external view that shows an example of the external view of the mobile information terminal 100. Also, these drawings illustrate an example of the front surface view and the back surface (rear surface) view of the mobile information terminal 100 of a case where the mobile information terminal 100 is a smart phone and the like, and illustration will be omitted with respect to the left and right side surfaces, the top and bottom surfaces, and so on.

On the front surface of the mobile information terminal 100, there are provided an operation indicator 124, the first image input section 133, the monaural speaker 142, and a touch screen 180. The operation indicator 124 reports the operation state of the mobile information terminal 100 by presence or absence of lighting or flickering of an LED. The touch screen 180 is configured to include the touch panel 123 and the display section 131. On the back surface of the mobile information terminal 100, there are provided the touch sensor 122, the second image input section 134, an auxiliary light emitter 135, and the stereo speaker 143. The auxiliary light emitter 135 can emit auxiliary light for compensating for light quantity shortage at the time of inputting an image from the second image input section 134. On the upper surface of the mobile information terminal 100, a power supply key 121p that is one of the operation key 121 is provided. On the lower surface of the mobile information terminal 100, there are provided the audio input section 145 and a p-USB input section 170u that is one of the expansion interface section 170.

Also, as shown in these drawings, the first image input section 133 is disposed on the front surface, and the second image input section 134 is disposed on the back surface that is a different surface from the first image input section 133. Hereinafter, there is a case where the first image input section 133 is referred to as “in-camera” and the second image input section 134 is referred to as “out-camera”.

Although the touch sensor 122 was provided on the back surface in the present example, the disposal position of the touch sensor 122 is not limited to the back surface, and may be a position different from the touch screen 180, for example the left and right side surfaces, the top and bottom surfaces, and a portion different from the touch screen 180 in the front surface.

### Software Configuration Example of Mobile Information Terminal

FIG. 1D is a software configuration diagram of the mobile information terminal 100, and shows an example of a configuration of software in the storage section 110 (or the ROM 113; the same hereinafter) and in the RAM 104. In the storage section 110, there are stored a basic operation program 1001, a lock control program 1002, a user authentication program 1003, and an other operation program 1009. Also, the storage section 110 includes an authentication information storage region 1011 that stores authentication information of a user of the mobile information terminal 100 and a various information storage region 1019 that stores other information.

The basic operation program 1001 stored in the storage section 110 is developed in the RAM 104, the main control section 101 further executes the developed basic operation program, and thereby a basic operation section 1101 is configured. In a similar manner, the lock control program 1002, the user authentication program 1003, and the other operation program 1009 are developed in the RAM 104 respectively, the main control section 101 further executes the respective basic operation programs having been developed, and thereby a lock control section 1102, a user authentication section 1103, and another operation section 1109 are configured. Also, the RAM 104 includes a temporary storage region 1200 that temporarily stores data generated at the time of executing respective operation programs according to the necessity.

Further, below, in order to simplify the explanation, a process of executing control of each operation block by that the main control section 101 develops the basic operation program 1001 stored in the storage section 110 to the RAM 104 and executes the basic operation program 1001 is described that the basic operation section 1101 executes control of each operation block. Similar description will be made also with respect to other operation programs.

The lock control section 1102 mainly executes control of making the operation state of the mobile information terminal 100 either a function lock state in which operation of various functions of the mobile information terminal 100 is restricted, or an unlock state in which operation of various functions of the mobile information terminal 100 is allowed. The function lock state means a state of receiving an operation instruction of a user authentication process for turning on or off of the power supply of the mobile information terminal 100, turning on or off of the sleep operation, and releasing the function lock state and not receiving other operation instructions. However, functions automatically executed by a terminal system such as searching of the access point, the base station, and the like as well as mail checking may be permitted in due course. Further, even under the function lock state, it may be configured that operation of generally all functions of the mobile information terminal 100 is not necessarily restricted but only a part of the functions is restricted.

The user authentication section 1103 mainly executes control of a user authentication process for confirming whether or not the operator of the mobile information terminal 100 is the normal user. In the present embodiment, as the user authentication process, the user authentication section 1103 controls PIN collation. Other authentication methods of executing the user authentication process by an operation instruction to the touch screen such as the password collation and the pattern collation are also applicable.

Also, respective operation programs described above may be in a state of being stored beforehand in at least one of the storage section 110 and the ROM 103 at the time point of the product shipment. The respective operation programs described above may be acquired from respective server devices on the network through the LAN communication section 161 or the telephone network communication section 162 and the like after the product shipment. Also, respective operation programs described above stored in a memory card, an optical disk, and the like may be acquired through the expansion interface section 170 and the like.

### Operation State Transition Example of Mobile Information Terminal

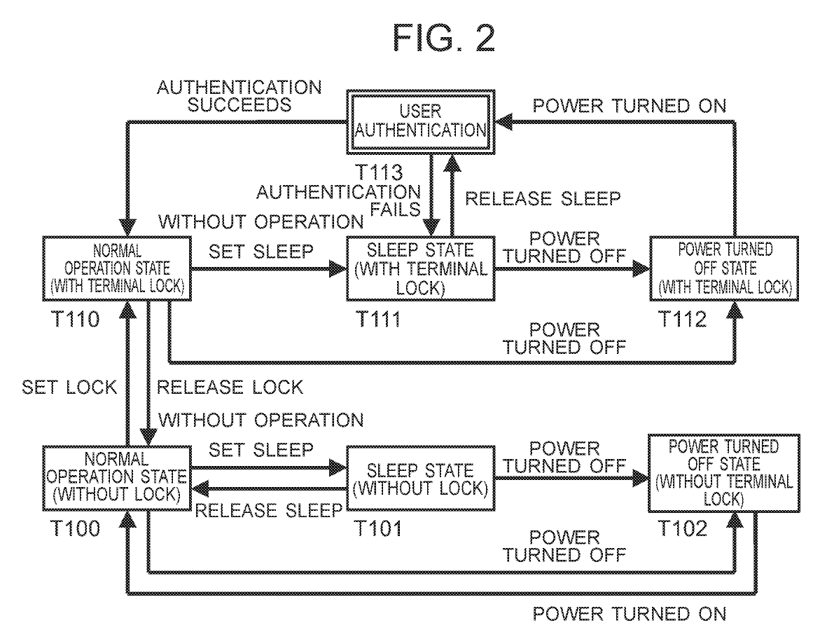

FIG. 2 is an operation state transition diagram that explains an example of a transition state of the operation state of the mobile information terminal 100.

The mobile information terminal 100 can set (validate) or release (invalidate) the terminal lock function by an operation instruction with respect to the function menu and the like. That is to say, by the operation instruction of setting or releasing the terminal lock function described above, the mobile information terminal 100 can switch a normal operation state T100 in a state where the terminal lock function is invalidated and a normal operation state T110 in a state where the terminal lock function is validated. At this time, the user authentication process may be requested.

Also, in a state where the terminal lock function is invalidated, the mobile information terminal 100 in the normal operation state T100 transits to a sleep state T101 when a predetermined time or more has elapsed without any operation or when the operator has instructed transition to the sleep state. Further, when the operator instructs to turn off the power supply in the normal operation state T100 or the sleep state T101, the mobile information terminal 100 transits to a power supply turned off state T102. When the operator instructs to release the sleep state in the sleep state T101 or when the operator instructs to turn on the power supply in the power supply turned off state T102, the mobile information terminal 100 transits to the normal operation state T100.

Meanwhile, in a state where the terminal lock function is validated, the mobile information terminal 100 in the normal operation state T110 transits to a sleep state T111 when a predetermined time or more has elapsed without any operation or when the operator has instructed transition to the sleep state. Further, when the operator instructs to turn off the power supply in the normal operation state T110 or the sleep state T111, the mobile information terminal 100 transits to a power supply turned off state T112. When the operator instructs to release the sleep state in the sleep state T111 or when the operator instructs to turn on the power supply in the power supply turned off state T112, the mobile information terminal 100 executes a user authentication process (T113). When it is successful to authenticate the operator in the user authentication process (T113), the mobile information terminal 100 transits to the normal operation state T110. When it is failed to authenticate the operator in the user authentication process (T113), the mobile information terminal 100 transits to the sleep state T111.

### Operation Control Example 1 of User Authentication Process

Hereinafter, an operation control example of the user authentication process of the mobile information terminal 100 will be explained.

As the user authentication process, the mobile information terminal 100 executes the PIN input method in which authentication of the user is executed by whether or not a numeric character string of plural digits obtained by continuously touching (selecting) numeric characters of the numeric character keyboard displayed on the touch screen 180 agrees to a numeric character string of authentication information having been set beforehand. Further, the mobile information terminal 100 controls whether the touch operation to the numeric character of the numeric character keyboard is valid or invalid according to the contact state of the finger to the touch sensor 122.

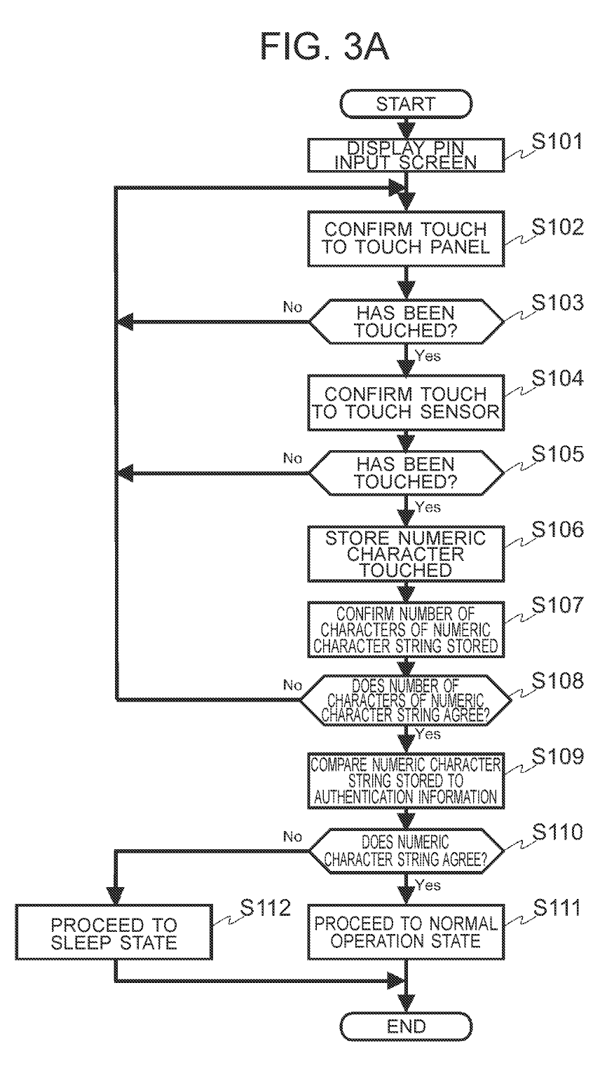

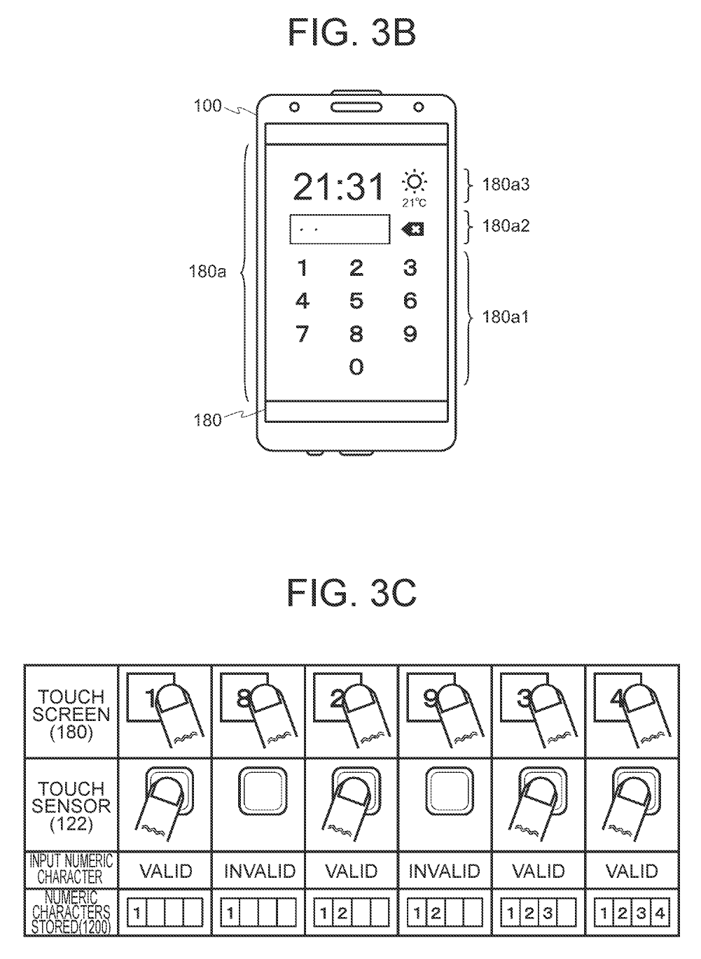

FIG. 3A is a flowchart of an example of the user authentication process by the PIN input method.

When the user executes instruction of sleep releasing in the sleep state T111 or when the user executes instruction of power supply turning on in the power supply turned off state T112, first, the user authentication section 1103 displays a PIN input screen 180a on the touch screen 180 (the display section 131) (S101). Then, presence or absence of the touch operation of the user to the touch screen 180 (the touch panel 123) is confirmed (S102). When there is no touch operation to the touch screen 180 (S103: No), the process returns to processing of S102. When there is touch operation to the touch screen 180 (S103: Yes), the process proceeds to processing of S104. Also, even when there is the touch operation to the touch screen 180, if the touch operation is to a region other than a numeric character keyboard region 180a1 described below, the process returns to processing of S102.

Next, the contact state of the finger of the user to the touch sensor 122 is confirmed (S104). When the finger of the user is not in contact with the touch sensor 122 (S105: No), the touch operation of the user in processing of S102 is made “invalid”, and the process returns to processing of S102. When the finger of the user is in contact with the touch sensor 122 (S105: Yes), the touch operation of the user in processing of S102 is made “valid”, and the numeric character touched by the user is stored in the temporary storage region 1200 (S106).

Next, the user authentication section 1103 confirms the number of characters of the numeric character string stored in the temporary storage region 1200 (S107). When the number of characters of the numeric character string confirmed in processing of S107 does not agree to the number of characters of the authentication information having been set beforehand and stored in the authentication information storage region 1011 by the user (S108: No), the process returns to processing of S102. When the number of characters of the numeric character string confirmed in processing of S107 agrees to the number of characters of the authentication information having been set beforehand and stored in the authentication information storage region 1011 by the user (S108: Yes), the process proceeds to processing of S109.

In processing of S109, the user authentication section 1103 compares the numeric character string stored in the temporary storage region 1200 and the authentication information having been set beforehand and stored in the authentication information storage region 1011 by the user, and transmits the result to the lock control section 1102 (S109).

When the numeric character string stored in the temporary storage region 1200 and the authentication information having been set beforehand and stored in the authentication information storage region 1011 by the user agree to each other (S110: Yes), according to the comparison result having been transmitted, the lock control section 1102 makes the operation state of the mobile information terminal 100 transit to the normal operation state T110 (S111) assuming that the authentication has succeeded. When the numeric character string stored in the temporary storage region 1200 and the authentication information having been set beforehand and stored in the authentication information storage region 1011 by the user do not agree to each other (S110: No), the operation state of the mobile information terminal 100 is returned to the sleep state T111 (S112) assuming that the authentication has failed.

FIG. 3B is a screen display drawing of an example of the PIN input screen displayed in processing of the flowchart shown in FIG. 3A.

The PIN input screen 180a is configured to include a numeric character keyboard region 180a1, an input result display region 180a2, and an other information display region 180a3. The numeric character keyboard region 180a1 becomes the valid region of touch operation at the time of PIN inputting. The input result display region 180a2 is a region for displaying the result of the touch operation by the user to the numeric character keyboard region 180a1. By displaying a character such as “⋅” when the user executes touch operation to the numeric character keyboard region 180a1, the event that the mobile information terminal 100 has received the operation instruction of the user is reported. The other information display region 180a3 is a region for displaying general information such as clock time information and weather information. It may be configured that the character such as “⋅” displayed in the input result display region 180a2 is displayed regardless that the touch operation of the user of processing of S102 is valid or invalid (presence or absence of contact of the finger of the user of processing of S104). Also, it may be configured to be displayed only when the touch operation is valid (or when there is contact of the finger).

FIG. 3C is a conceptual drawing of operation of an example of a flow of operation of the user authentication process by the PIN input method of the flowchart shown in FIG. 3A.

As shown in the drawing, the touch operation of the user to the touch screen 180 is executed in the order of “1”, “8”, “2”, “9”, “3”, and “4”. Also, in the touch operation of the user to the touch screen 180, it is assumed that the finger of the user is in contact with the touch sensor 122 at the time of the touch operation to “1”, “2”, “3”, and “4”, and that the finger of the user is not in contact with the touch sensor 122 at the time of the touch operation to “8” and “9”. In this case, out of the touch operation of the user to the touch screen 180, the touch operation to “1”, “2”, “3”, and “4” becomes “valid”, and respective numeric characters described above are stored in the temporary storage region 1200. Also, storage of the numeric characters in the temporary storage region 1200 is executed not by overwriting but by recording (stacking).

When authentication information set beforehand and stored in the authentication information storage region 1011 by the user is a numeric character string of four digits, the numeric character of “4” to which touch operation was performed is stored in the temporary storage region 1200, and comparison of the numeric character string is executed at a time point when the number of characters of the numeric character string stored in the temporary storage region 1200 becomes four digits.

As explained above, the mobile information terminal 100 receives input operation of the PIN code using both of contact to the touch screen 180 and contact to the touch sensor 122. Thereby, operation of the user authentication process by the PIN input method can be controlled so that the touch operation by the user to the touch screen 180 is validated or invalidated according to the contact state of the finger of the user to the touch sensor 122. Therefore, even when a third party may peep the touch operation of the user to the touch screen 180, since contact of the finger to the touch sensor 122 that is located on the back surface cannot be confirmed, it is hard to grasp the PIN precisely. That is to say, security of the mobile information terminal 100 improves, and usability improves. The control described above is valid also in the case of the user authentication process of the password input method and the pattern input method.

### Operation Control Example 2 of User Authentication Process

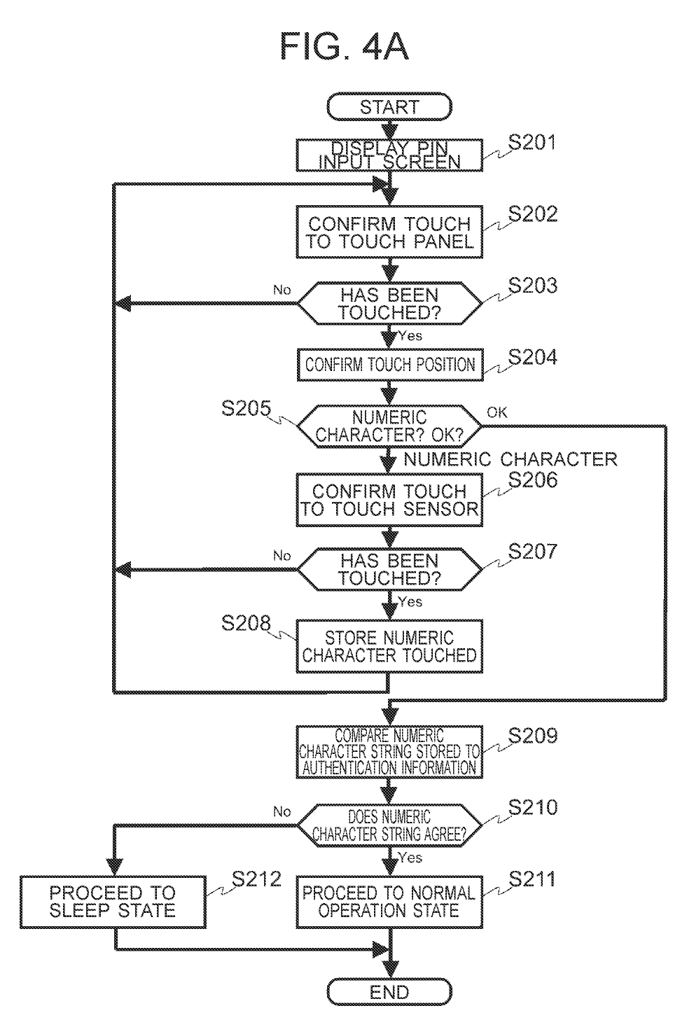

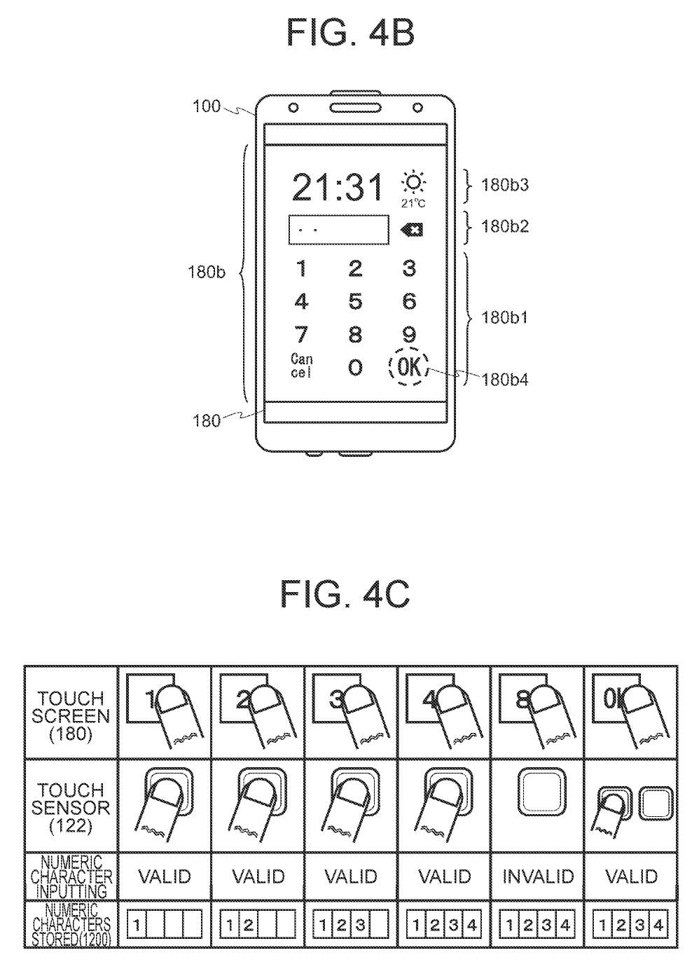

FIG. 4A is a flowchart of an example of the user authentication process by the PIN input method.

When the user executes instruction of sleep releasing in the sleep state T111 or when the user executes instruction of power supply turning on in the power supply turned off state T112, first, the user authentication section 1103 displays a PIN input screen 180b on the touch screen 180 (the display section 131) (S201). Then, presence or absence of the touch operation of the user to the touch screen 180 (the touch panel 123) is confirmed (S202). When there is no touch operation to the touch screen 180 (S203: No), the process returns to processing of S202. When there is touch operation to the touch screen 180 (S203: Yes), the process proceeds to processing of S204. Also, even when there is the touch operation to the touch screen 180, if the touch operation is to a region other than a numeric character keyboard region 180b1 described below, the process returns to processing of S202.

Next, the touch position of the touch operation of the user is confirmed (S204). When the touch position of the touch operation of the user is “numeric character” (S205: numeric character), the process proceeds to processing of S206. When the touch position of the touch operation of the user is “OK” (S205: OK), the process proceeds to S209. When the touch position of the touch operation of the user is “Cancel” (not illustrated), the user authentication process is interrupted, and the operation state of the mobile information terminal 100 is returned to the sleep state T111.

In processing of S206, the contact state of the finger of the user to the touch sensor 122 is confirmed (S206). When the finger of the user is not in contact with the touch sensor 122 (S207: No), the touch operation of the user in processing of S202 is made “invalid”, and the process returns to processing of S202. When the finger of the user is in contact with the touch sensor 122 (S207: Yes), the touch operation of the user in processing of S202 is made “valid”, and the numeric character touched by the user is stored in the temporary storage region 1200 (S208). Thereafter, the process returns to processing of S202.

In processing of S209, the user authentication section 1103 compares the numeric character string stored in the temporary storage region 1200 and the authentication information having been set beforehand and stored in the authentication information storage region 1011 by the user, and transmits the result to the lock control section 1102 (S209).

When the numeric character string stored in the temporary storage region 1200 and the authentication information having been set beforehand and stored in the authentication information storage region 1011 by the user agree to each other (S210: Yes), according to the comparison result having been transmitted, the lock control section 1102 makes the operation state of the mobile information terminal 100 transit to the normal operation state T110 (S211) assuming that the authentication has succeeded. When the numeric character string stored in the temporary storage region 1200 and the authentication information having been set beforehand and stored in the authentication information storage region 1011 by the user do not agree to each other (S210: No), the operation state of the mobile information terminal 100 is returned to the sleep state T111 (S212) assuming that the authentication has failed.

FIG. 4B is a screen display drawing of an example of the PIN input screen displayed in processing of the flowchart shown in FIG. 4A.

The PIN input screen 180b is configured to include the numeric character keyboard region 180b1, an input result display region 180b2, and an other information display region 180b3. The numeric character keyboard region 180b1 is the valid region of touch operation at the time of PIN inputting, and there are an “OK” display 180b4 and a “Cancel” display.

FIG. 4C is a conceptual drawing of operation of an example of a flow of operation of the user authentication process by the PIN input method of the flowchart shown in FIG. 4A.

As shown in the drawing, the touch operation of the user to the touch screen 180 is executed in the order of “1”, “2”, “3”, “4”, “8”, and “OK”. Also, in the touch operation of the user to the touch screen 180, it is assumed that the finger of the user is in contact with the touch sensor 122 at the time of the touch operation to “1”, “2”, “3”, and “4”, and that the finger of the user is not in contact with the touch sensor 122 at the time of the touch operation to “8”. In this case, out of the touch operation of the user to the touch screen 180, the touch operation to “1”, “2”, “3”, and “4” becomes “valid”, and respective numeric characters described above are stored in the temporary storage region 1200. At this time, storage of the numeric characters in the temporary storage region 1200 is executed not by overwriting but by recording (stacking).

The touch operation to “OK” may be made “valid” only when the finger of the user is in contact with the touch sensor 122, and may be made “valid” irrespective of presence or absence of contact of the finger of the user to the touch sensor 122. This operation control example is different from the operation control example described above in that comparison of the numeric character string is executed not at the time point when the number of characters of the numeric character string agrees but at the time point when “OK” is touched.

### [Modification]

The touch sensor 122 may be a fingerprint sensor that can read a fingerprint pattern. In this case, control is executed so that, even when the finger of the user is in contact with the touch sensor 122 in processing of S104 (or S206), the touch operation of the user of the processing of S102 (or S202) described above is made “valid” only in the case of agreeing to the fingerprint pattern of the finger registered beforehand. For example, control can be executed so that the touch operation of the user is processed to be “valid” when the finger of the user contacting the touch sensor 122 is the pointer finger of the left hand, and so that the touch operation of the user is processed to be “invalid” when the finger of the user contacting the touch sensor 122 is other than the pointer finger of the left hand and when the finger of the user is not in contact with the touch sensor 122.

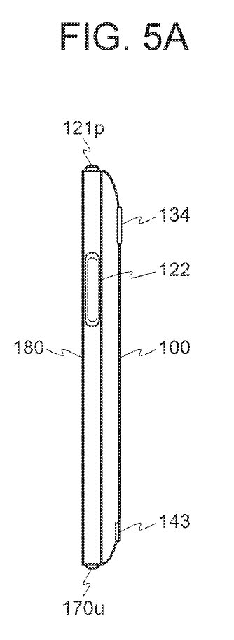

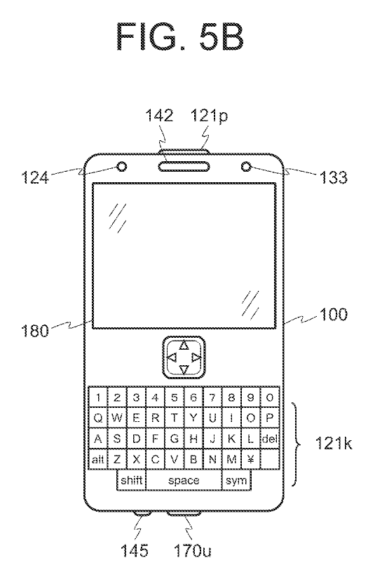

The position where the touch sensor 122 is disposed is not limited to the back surface of the mobile information terminal 100. FIG. 5A is a side surface external view of a modification of the mobile information terminal 100. As shown in the drawing, the touch sensor 122 may be disposed also on the side surface of the mobile information terminal 100. The touch sensor 122 may be disposed also on either a top or bottom surface. It is suitable to dispose the touch sensor 122 at a position where the finger of the user easily contacts when the mobile information terminal 100 is held. Alternatively, the touch sensor 122 may be made a separate device connected to the mobile information terminal 100 by wire communication or wireless communication. It is suitable that the touch sensor 122 is disposed or configured so as to be incapable of being viewed simultaneously with the touch screen 180.

PIN inputting in the user authentication process is not limited to one executed through the touch screen 180, but may be one executed through the operation key 121. FIG. 5B is a front surface external view of the modification of the mobile information terminal 100. A keyboard 121k is one of the operation key 121 that is configured of hard buttons. By pressing down each key of the keyboard 121k, a character can be inputted. Even when PIN inputting is executed through the keyboard 121k, whether inputting of a character by pressing down of each key of the keyboard 121k is valid or invalid may be controlled according to the contact state of the finger of the user to the touch sensor 122.

### Second Embodiment

Hereinafter, explanation will be made with respect to the second embodiment of the present invention. Also, the basic configuration of the second embodiment is similar to that of the first embodiment, the different points between the present embodiment and the first embodiment will be mainly explained below, and explanation for portions common to them will be omitted to the greatest possible extent in order to avoid duplication.

In the past, the touch sensor was used for transition to the fingerprint authentication and the home screen, whereas the touch screen was mainly used for inputting numeric characters or characters, and input operation combining them was not executed. Therefore, in the present embodiment, it is aimed to achieve further more input operations not only by using each of plural input sections independently but also by using the plural input sections in combination and thereby using the same number of pieces of the input sections, and to effectively utilize hardware resources.

As the user authentication process, the mobile information terminal 100 of the present embodiment executes the PIN input method in which authentication of the user is executed by whether or not a numeric character string of plural digits obtained by continuously touching (selecting) numeric characters of the numeric character keyboard displayed on the touch screen 180 agrees to a numeric character string of authentication information having been set beforehand. Further, the mobile information terminal 100 controls the function restriction state after transition to the normal operation state T110 according to the contact state of the finger to the touch sensor 122.

### Operation Control Example of User Authentication Process

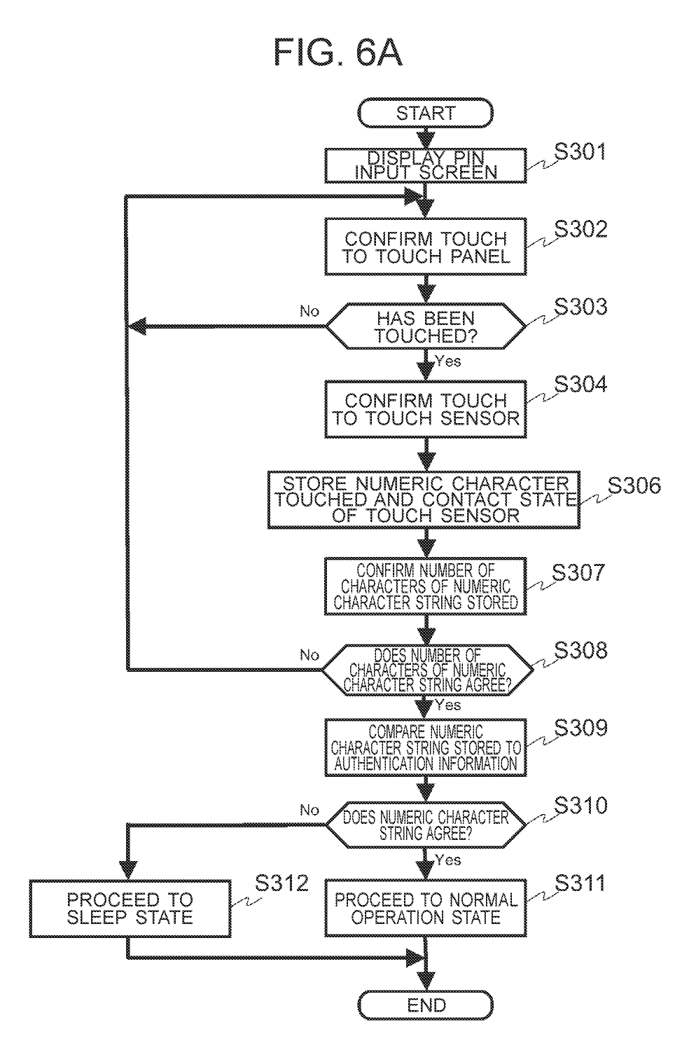

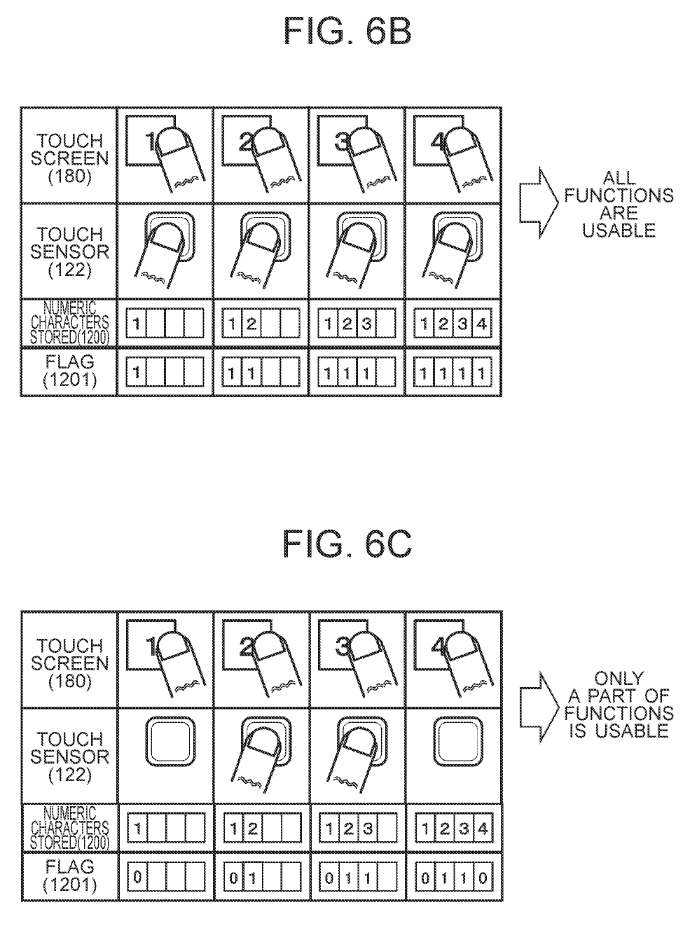

FIG. 6A is a flowchart of an example of the user authentication process by the PIN input method.

The user authentication process of the present embodiment is executed basically by a procedure similar to the flowchart shown in FIG. 3A. Processing of S301 to S304 has the same motion as processing of S101 to S104. In processing of S306, a numeric character touched by the user in processing of S302 is stored in the temporary storage region 1200 along with the contact state of the finger of the user confirmed in S304. For example, a flag region 1201 is arranged in association with the numeric character of the temporary storage region 1200. Also, a flag “1” is stored in the flag region 1201 when the finger is in contact (when touching to the touch sensor has been confirmed) at the time the numeric character is inputted, and a flag “0” is stored in the flag region 1201 when the finger is not in contact (when touching to the touch sensor cannot be confirmed) at the time the numeric character is inputted. Processing of S307 to S312 has the same motion as processing of S107 to S112.

FIG. 6B and FIG. 6C are conceptual drawings of operation of an example of a flow of operation of the user authentication process by the PIN input method of the flowchart shown in FIG. 6A.

As shown in these drawings, the touch operation of the user to the touch screen 180 is executed in the order of “1”, “2”, “3”, and “4”. Also, in the touch operation of the user to the touch screen 180, when the finger of the user is in contact with the touch sensor 122 at the time of the touch operation to “1”, “2”, “3”, and “4” (FIG. 6B), control is executed so that all functions provided to the mobile information terminal 100 become usable in the normal operation state T110 after the user authentication process has succeeded. Meanwhile, in the touch operation of the user to the touch screen 180, when the finger of the user is in contact with the touch sensor 122 only at the time of the touch operation to “2” and “3”, (FIG. 6C), control is executed so that only a part of the functions out of all functions provided to the mobile information terminal 100 becomes usable in the normal operation state T110 after the user authentication process has succeeded.

That is to say, when contact of the finger of the user to the touch sensor 122 is involved for all touch operation of the numeric characters configuring PIN, all functions provided to the mobile information terminal 100 are made a usable state. When contact of the finger of the user to the touch sensor 122 is involved only for a part of the touch operation of the numeric characters configuring PIN, only a part of the functions out of all functions provided to the mobile information terminal 100 is made a usable state. For example, such selective use becomes possible that PIN inputting (user authentication process) as per the procedure shown in FIG. 6B is required when money transaction, various kinds of settlement process, and the like are to be executed using the mobile information terminal 100, and that PIN inputting (user authentication process) as per the procedure shown in FIG. 6C is enough when charge-free moving image reproduction and the like are to be executed, and so on.

Also, in the mobile information terminal 100 of the present embodiment, success and failure of the user authentication process is determined solely by comparison of the numeric character string stored in the temporary storage region 1200 and the authentication information having been set beforehand and stored in the authentication information storage region 1011 by the user, and not by the contact state of the finger of the user to the touch sensor 122. All of the touch operation of the user to the touch screen 180 is handled to be “valid” irrespective of contact of the finger of the user to the touch sensor 122.

As explained above, in the mobile information terminal 100, the restriction state of the function that is usable after transition to the normal operation state T110 can be controlled according to the contact state of the finger of the user to the touch sensor 122 at the time of operation of the user authentication process by the PIN input method. That is to say, usability of the mobile information terminal 100 improves. The control described above is also valid in the case of the user authentication process of the password input method and the pattern input method.

### [Modification]

When the number of digit of the numeric character string of the authentication information having been set beforehand and stored in the authentication information storage region 1011 by the user is four digits, the number of the numeric character required to be inputted in the PIN input process is four pieces. In this case, it is also possible to control the restriction state of the function that is usable after transition to the normal operation state T110 according to the number of times of occurrence of contact of the finger of the user to the touch sensor 122 in contrast with four times of the touch operation to the touch screen 180.

For example, applications that can be executed by the mobile information terminal 100 are divided into four groups, and when contact of the finger of the user to the touch sensor 122 is only once in contrast with four times of the touch operation to the touch screen 180, only the applications belonging to the first group are made usable. When contact of the finger of the user to the touch sensor 122 is two times, only the applications belonging to the first group and the second group are made usable. When contact of the finger of the user to the touch sensor 122 is three times, only the applications belonging to the first group, the second group, and the third group are made usable. When contact of the finger of the user to the touch sensor 122 is four times, the applications belonging to all groups are made usable.

Alternatively, for example, applications that can be executed by the mobile information terminal 100 are divided into four groups, and when contact of the finger of the user to the touch sensor 122 is only once in contrast with four times of the touch operation to the touch screen 180, only the applications belonging to the first group are made usable. When contact of the finger of the user to the touch sensor 122 is two times, only the applications belonging to the second group are made usable. When contact of the finger of the user to the touch sensor 122 is three times, only the applications belonging to the third group are made usable. When contact of the finger of the user to the touch sensor 122 is four times, only the applications belonging to the fourth group are made usable.

Alternatively, it is also possible for example to divide applications that can be executed by the mobile information terminal 100 into four groups and to execute control as follows according to operation with respect to the touch screen 180 and contact to the touch sensor 122. When contact of the finger of the user to the touch sensor 122 is only once in contrast with four times of the touch operation to the touch screen 180 and the contact of the finger of the user to the touch sensor 122 is executed combined with the first touch operation to the touch screen 180, only the applications belonging to the first group are made usable. When contact of the finger of the user to the touch sensor 122 is only once and the contact of the finger of the user to the touch sensor 122 is executed combined with the second touch operation to the touch screen 180, only the applications belonging to the second group are made usable. When contact of the finger of the user to the touch sensor 122 is only once and the contact of the finger of the user to the touch sensor 122 is executed combined with the third touch operation to the touch screen 180, only the applications belonging to the third group are made usable. When contact of the finger of the user to the touch sensor 122 is only once and the contact of the finger of the user to the touch sensor 122 is executed combined with the fourth touch operation to the touch screen 180, only the applications belonging to the fourth group are made usable. Further, it is also possible to execute control similar to the above when contact of the finger of the user to the touch sensor 122 is in two times or three times.

Also, such control is also possible that, when the user stores beforehand two kinds of the authentication information in the authentication information storage region 1011 and there is contact of the finger of the user to the touch sensor 122, the user authentication process is executed by comparison to the first authentication information, and that when there is no contact of the finger of the user, the user authentication process is executed by comparison to the second authentication information. Further, it is also possible that, in the normal operation state T110 after succeeding in the user authentication process by comparison to the first authentication information, control is executed so that all functions provided to the mobile information terminal 100 become usable, whereas in the normal operation state T110 after succeeding in the user authentication process by comparison to the second authentication information, control is executed so that only a part of the functions out of all functions provided to the mobile information terminal 100 becomes usable.

Further, such control is also possible that the touch sensor 122 is made a fingerprint sensor, the user stores beforehand three kinds of the authentication information in the authentication information storage region 1011, the user authentication process is executed by comparison to the first authentication information when the finger contacting the touch sensor 122 is the first finger of the user, the user authentication process is executed by comparison to the second authentication information when the finger contacting the touch sensor 122 is the second finger of the user, and the user authentication process is executed by comparison to the third authentication information when there is no contact of the finger of the user to the touch sensor 122. In this case, it is also possible to control a function that can be used in the normal operation state T110 after succeeding in the user authentication process according to which of the authentication information comparison was made. Also, the first authentication information and the second authentication information can be stored in relation to the fingerprint pattern information of the first finger and the fingerprint pattern information of the second finger respectively.

### Third Embodiment

Hereinafter, explanation will be made with respect to the third embodiment of the present invention. Also, the basic configuration of the third embodiment is similar to that of the first embodiment, the different points between the present embodiment and the first embodiment will be mainly explained below, and explanation for portions common to them will be omitted to the greatest possible extent in order to avoid duplication.

In the past, for switching between the capital letter and the small letter of the alphabet for example, the “Caps Lock” button or the “Shift” button were operated. In that case, only the touch panel was used as the input section, and the letter type was changed before inputting the character or simultaneous pressing of the “Shift” button and the character key. In the present embodiment, in changing operation of the input letter type, hardware different from the touch panel is used in combination, and thereby effective utilization of the hardware resources is aimed. Therefore, the mobile information terminal 100 according to the present embodiment executes control of the input letter type according to the contact state of the finger to the touch sensor 122 at the time of inputting characters using the software keyboard.

### Operation Control Example of Character Input Process

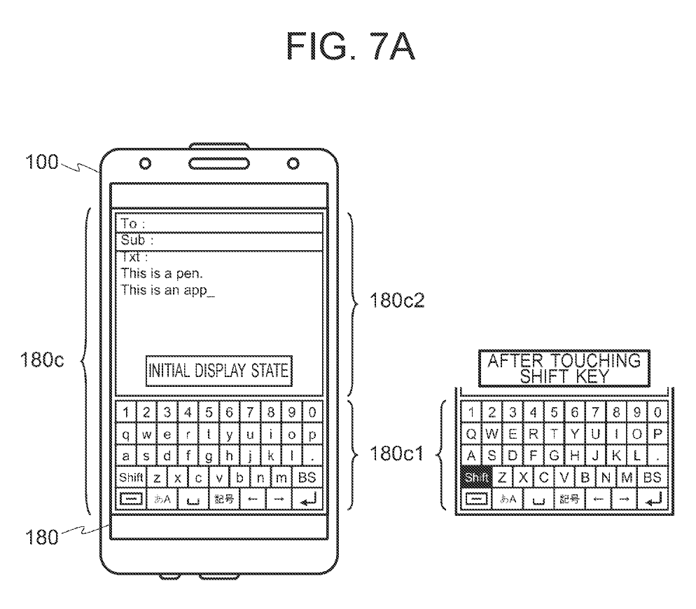

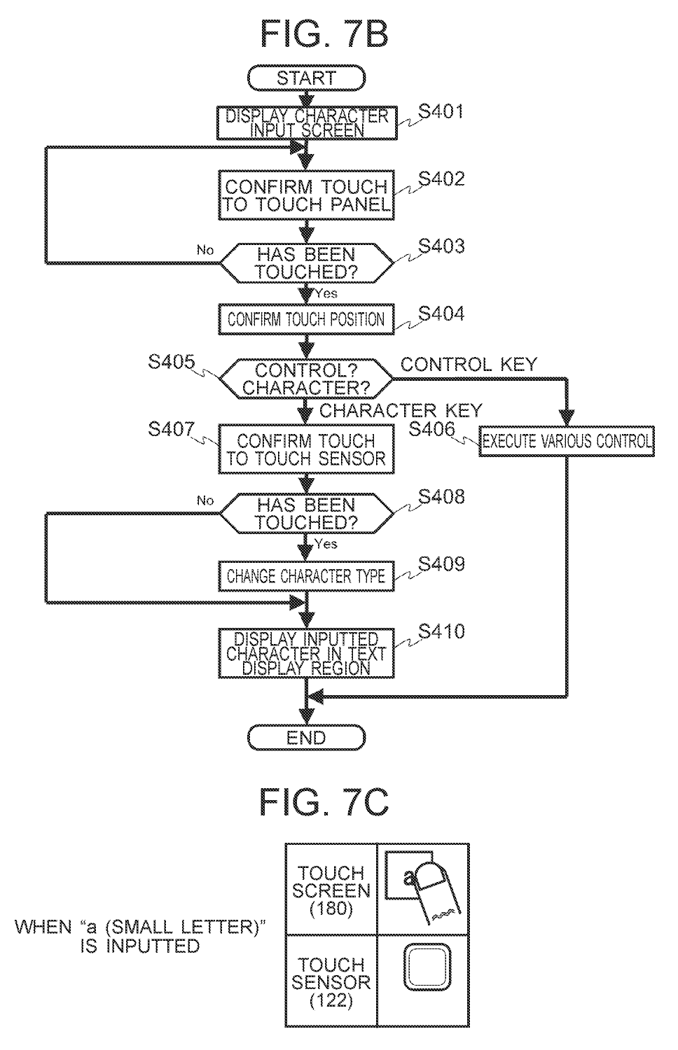

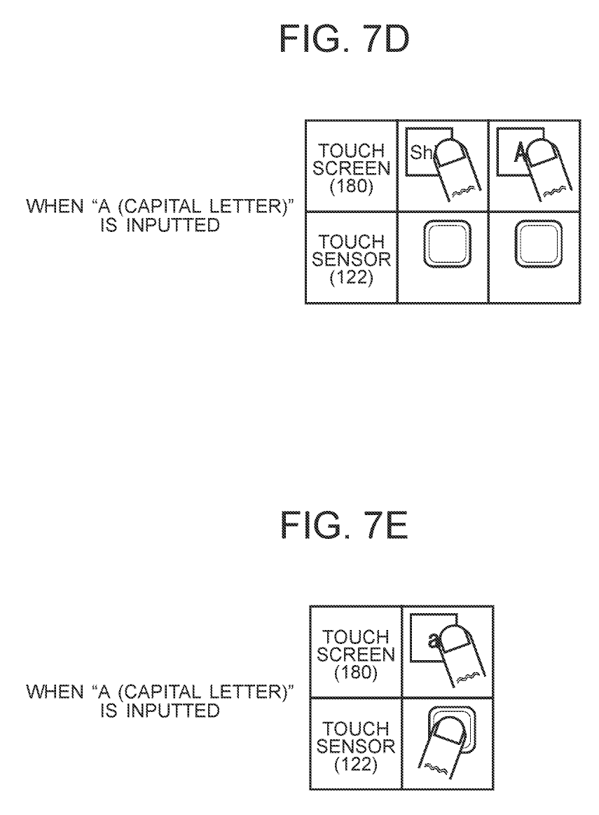

FIG. 7A is a screen display drawing of an example of the character input screen that is displayed at the time of executing character inputting by the mobile information terminal 100.

A character input screen 180c is configured to include a software keyboard region 180c1 and a text display region 180c2. Character inputting is executed based on touch operation to each character key and other control keys of the software keyboard region 180c1. The result of it is displayed in the text display region 180c2. With respect to each character key of the software keyboard region 180c1, alphabets of the small letter are displayed in the initial display state. Also, by touching the “Shift” key, display of each character key is changed from the small letter to the capital letter, and alphabets of the capital letter can be inputted.

FIG. 7B is a flowchart of an example of the character input process.

When the user starts an application that is for executing character inputting, first, the character input screen 180c is displayed (S401). Then, presence or absence of touch operation of the user to the touch screen 180 (the touch panel 123) is confirmed (S402). When there is no touch operation to the touch screen 180 (S403: No), the process returns to processing of S402. When there is touch operation to the touch screen 180 (S403: Yes), the process proceeds to processing of S404. Also, even when there is touch operation to the touch screen 180, if it is touch operation to a region other than the software keyboard region 180c1, the process returns to processing of S402.

Next, the touch position of the touch operation of the user is confirmed (S404). When the touch position of the touch operation of the user is a “control key” (S405: control key), the process proceeds to processing of S406. When the touch position of the touch operation of the user is a “character key” (S405: character key), the process proceeds to S407. In processing of S406, predetermined control is executed according to the kind of the control key having been touched (S406). For example, when the control key having been touched is the “Shift” key, the letter type of each character key displayed in the software keyboard region 180c1 is changed to the capital letter.

In processing of S407, the contact state of the finger of the user to the touch sensor 122 is confirmed (S407). When the finger of the user is not in contact with the touch sensor 122 (S408: No), a character inputted in the touch operation of the user in processing of S402 is displayed in the text display region 180c2 by the character type that remains unchanged (S410). When the finger of the user is in contact with the touch sensor 122 (S408: Yes), the character inputted in the touch operation of the user in processing of S402 is changed in the character type (S409), and is displayed in the text display region 180c2 (S410).

FIG. 7C to FIG. 7E are conceptual drawings of operation of an example of a flow of operation of the character input process of the flowchart shown in FIG. 7B.

When the user is to input a small letter of an alphabet, the user only has to touch the character key of each alphabet in the initial display state (FIG. 7C). In this case, the user only has to execute only one operation instruction. When the user is to input a capital letter of an alphabet, first, the user is to touch the “Shift” key in the initial display state. Then, display of each character key of the alphabet in the software keyboard region 180c1 is changed from the small letter to the capital letter. Next, the user only has to touch the character key of each alphabet (FIG. 7D). In this case, two-time operation instruction is required.

Meanwhile, when the user is to input a capital letter of an alphabet, the user may touch a character key of each alphabet in the initial display state in a state where the finger of the user is in contact with the touch sensor 122 (FIG. 7E). In this case, only one operation instruction is enough. It is controlled so that the character input result displayed in the text display region 180c2 is in the capital letter although display of each character key of the alphabet in the software keyboard region 180c1 remains unchanged as the small letter.

That is to say, in the mobile information terminal 100 of the present embodiment, by touching a character key of the software keyboard region 180c1 in a state where the finger of the user is in contact with the touch sensor 122, change of the character type can be controlled. That is to say, usability of the mobile information terminal 100 improves.

### [Modification]

It is also possible to control decoration of a character according to presence or absence of contact of the finger of the user to the touch sensor 122. For example, it is controlled so that inputting is executed as the standard character type when touch operation is executed to the software keyboard region 180c1 in a state where there is no contact of the finger of the user to the touch sensor 122, and decoration of italics, bold letter, and the like is executed with respect to a character having been inputted when touch operation is executed to the software keyboard region 180c1 in a state where there is contact of the finger of the user to the touch sensor 122. It is also possible to execute decoration of an underline, strike-through, and the like. It is also possible to control the font type and the size (point number).

Further, it is also possible to make the touch sensor 122 a fingerprint sensor and to control change and decoration of the character type according to the kind of the finger of the user having touched the touch sensor 122. For example, it is also possible to execute control so that change to the capital letter is executed when the finger having touched the touch sensor 122 is the first finger of the user, decoration of italics is executed when the finger having touched the touch sensor 122 is the second finger, decoration of the underline is executed when the finger having touched the touch sensor 122 is the third finger, and inputting of the standard letter (small letter) is executed when there is no contact of the finger of the user to the touch sensor 122. In this case, the relation between the finger kind and the change or decoration control is stored beforehand in the various information storage region 1019 as a table.

The present control is also applicable to inputting of the Japanese language, and change to the dull sound or the semi-dull sound and so on may be executed.

### Fourth Embodiment

Hereinafter, explanation will be made with respect to the fourth embodiment of the present invention. Also, the basic configuration of the fourth embodiment is similar to that of the first embodiment, the different points between the present embodiment and the first embodiment will be mainly explained below, and explanation for portions common to them will be omitted to the greatest possible extent in order to avoid duplication.

The mobile information terminal 100 of the present embodiment executes control of the telephone communication (telephone call) function according to the contact state of the finger to the touch sensor 122. Particularly, in a mobile information terminal that can use plural SIMs, when selection operation of the SIM is executed only by a touch screen, transition from the selection operation screen of the SIM to the telephone communication function screen is required, and screen operation is troublesome. Therefore, in the present embodiment, improvement of operability of the selection operation of the SIM is sought for by effective utilization of the hardware.

### Hardware Configuration Example of Mobile Information Terminal

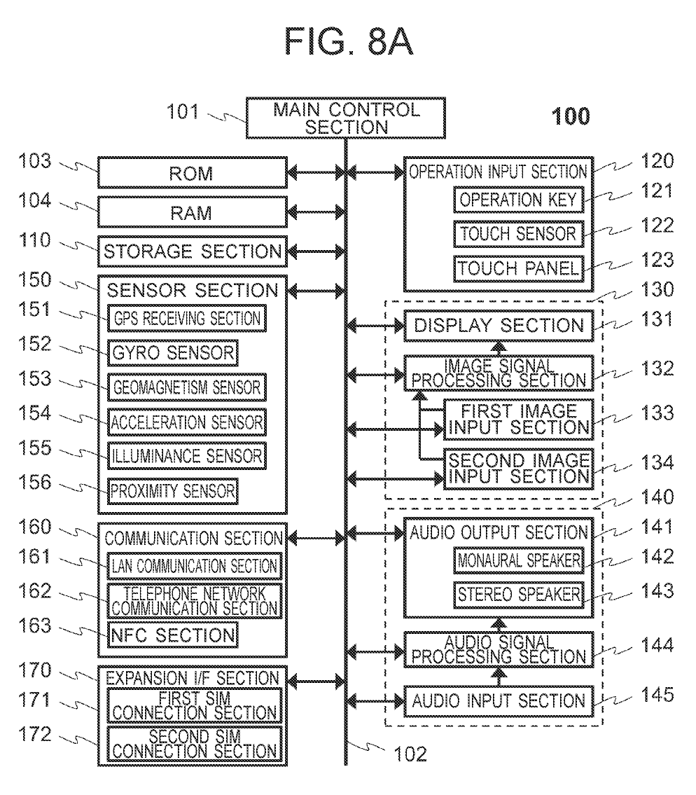

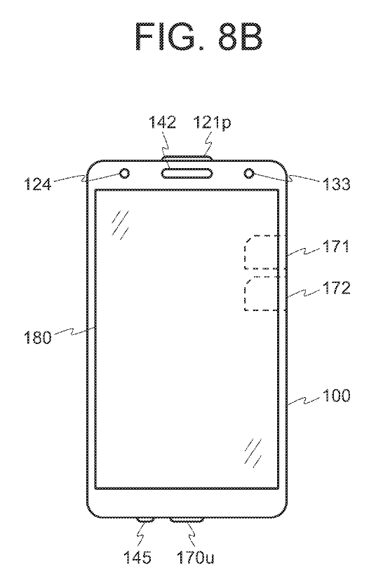

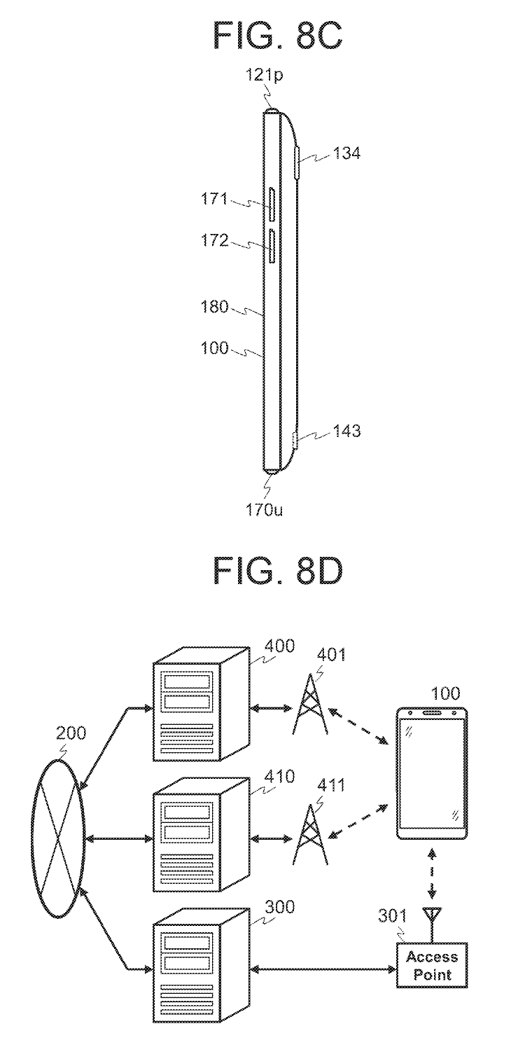

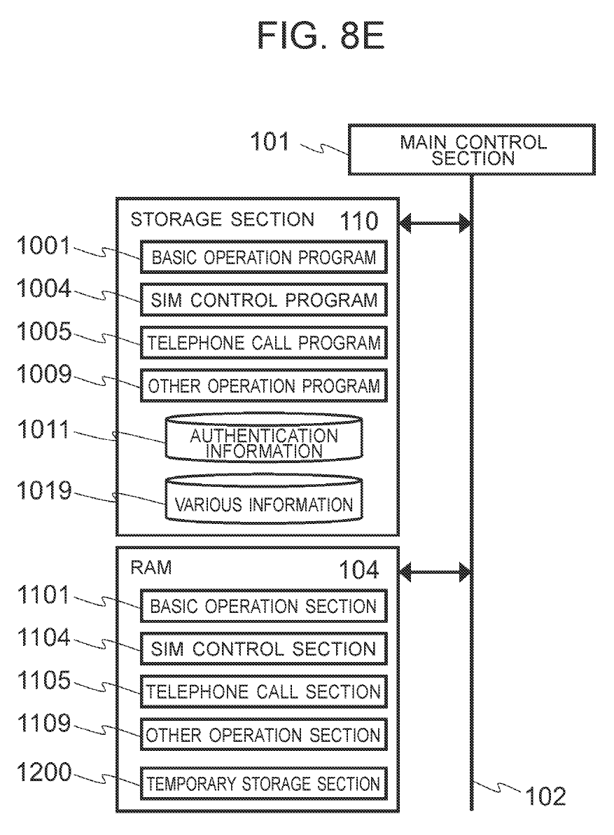

FIG. 8A is a hardware configuration diagram that shows an example of the internal configuration of the mobile information terminal 100. The mobile information terminal 100 of the present embodiment includes a first SIM connection section 171 and a second SIM connection section 172 in an expansion interface section 170. To the first SIM connection section 171 and the second SIM connection section 172, a card which is issued by a communication business operator and in which subscriber information and the like are recorded such as a SIM (Subscriber Identify Module) and a UIM (User Identify Module) (will be hereinafter referred to as a SIM group) can be connected respectively. With respect to the mobile information terminal 100, the telephone number is determined based on the subscriber information and the like recorded in the SIM group at the time of executing telephone call and the like through a mobile telephone communication network. The SIM group may further record private information such as the telephone directory (address book), personal identify information for credit settlement, and so on other than the subscriber information and the like described above.

Also, the telephone network communication section 162 may include a first telephone network communication section and a second telephone network communication section which correspond to the first SIM connection section 171 and the second SIM connection section 172 respectively. It is also possible that only one telephone network communication section 162 selectively corresponds to the first SIM connection section 171 and the second SIM connection section 172.

### External View Example of Mobile Information Terminal

FIG. 8B is a front surface external view that shows an example of the external view of the mobile information terminal 100. FIG. 8C is a side surface external view that shows an example of the external view of the mobile information terminal 100.

With respect to the first SIM connection section 171 and the second SIM connection section 172, an insertion port is provided in the side surface of the mobile information terminal 100. By inserting the SIM group to the insertion port, connection with the SIM group is enabled. However, the layout of the first SIM connection section 171 and the second SIM connection section 172 on the case of the mobile information terminal 100 may be in the upper or lower surfaces and the like, and is not limited to the example described above.

### System Configuration Example Including Mobile Information Terminal

FIG. 8D is a system configuration diagram that shows an example of the communication system including the mobile information terminal 100.

The communication system is configured to include the mobile information terminal 100, a wide area public network such as an internet 200, an ISP (Internet Service Provider) 300 and a wireless communication access point 301 for it, a first mobile telephone communication network 400 and a base station 401 for it, and a second mobile telephone communication network 410 and a base station 411 for it.

The mobile information terminal 100 includes two SIM connection sections (the first SIM connection section 171 and the second SIM connection section 172), and can switch or select the network optionally. That is to say, telephone call can be executed while optionally switching or selecting the telephone numbers that are determined by respective SIM group and the like. When the first SIM group connected to the first SIM connection section 171 has been validated, telephone communication (telephone call) is executed through the first mobile telephone communication network 400 and the base station 401 for it. The first SIM group is a SIM group issued by a business operator of the first mobile telephone communication network 400. When the second SIM group connected to the second SIM connection section 172 has been validated, telephone communication (telephone call) is executed through the second mobile telephone communication network 410 and the base station 411 for it. The second SIM group is a SIM group issued by a business operator of the second mobile telephone communication network 410.

### Software Configuration Example of Mobile Information Terminal

FIG. 8E is a software configuration diagram of the mobile information terminal 100, and shows an example of a configuration of the software in the storage section 110 (or the ROM 113; the same hereinafter) and the RAM 104. In the storage section 110, there are stored the basic operation program 1001, a SIM control program 1004, a telephone call program 1005, and the other operation program 1009. Also, the SIM control program 1004 and the telephone call program 1005 stored in the storage section 110 are developed respectively in the RAM 104, the main control section 101 further executes respective operation programs described above having been developed, and thereby a SIM control section 1104 and a telephone call section 1105 are configured.

The SIM control section 1104 executes setting control for which of the first SIM group or the second SIM group is to be validated, the first SIM group being connected to the first SIM connection section 171, the second SIM group being connected to the second SIM connection section 172. Alternatively, when both of the first SIM group and the second SIM group have been validated, the first SIM group being connected to the first SIM connection section 171, the second SIM group being connected to the second SIM connection section 172, the SIM control section 1104 executes setting control for which of the SIM groups is to be made a SIM group that is used in priority. The telephone call section 1105 executes management of the telephone directory at the time of telephone call, inputting or selection control of the transmission destination telephone number, control of outgoing call or incoming call process, and so on.

### Operation Control Example of Telephone Call Process

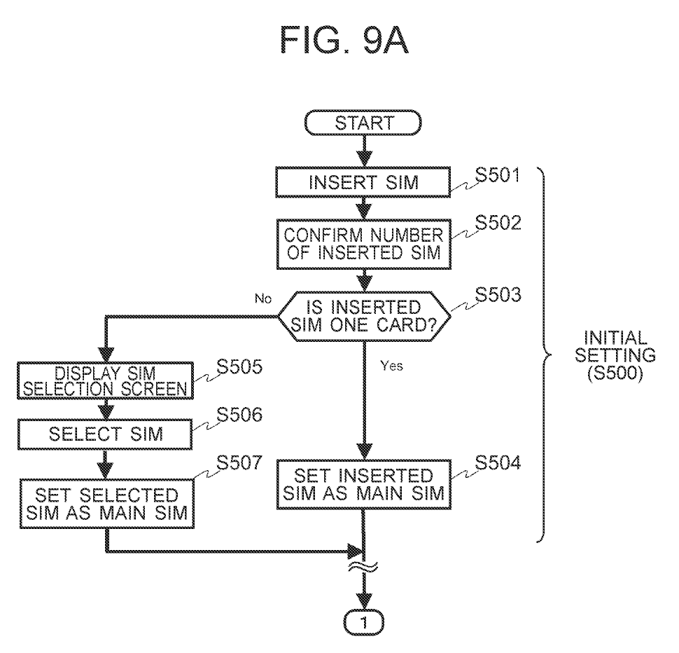

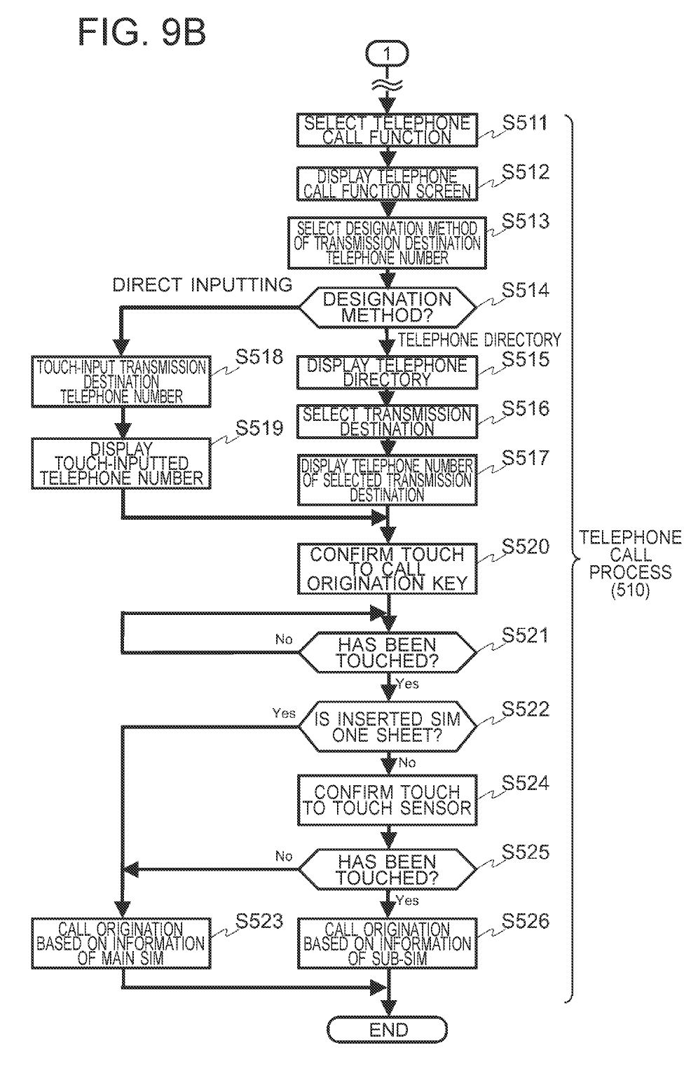

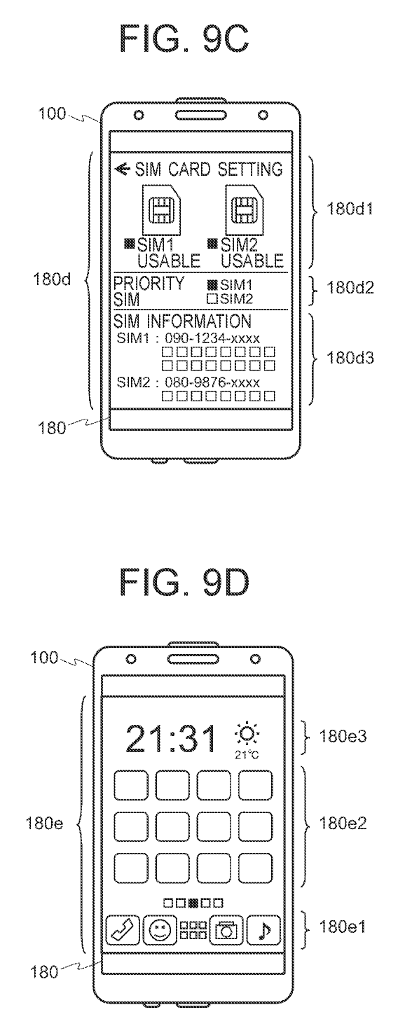

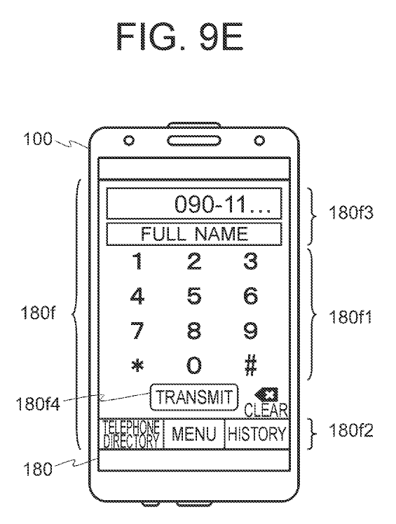

FIG. 9A and FIG. 9B are flowcharts of an example of the operation control at the time telephone call is executed using the mobile information terminal 100.

As the initial setting (S500), processing of the following procedure shown in FIG. 9A is executed beforehand.

In the initial setting process, first, the user inserts the SIM group into both of the first SIM connection section 171 and the second SIM connection section 172, or any of the first SIM connection section 171 and the second SIM connection section 172 (S501), the SIM group being issued from the business operator of the first mobile telephone communication network 400, the second mobile telephone communication network 410, and so on. Then, the SIM control section 1104 of the mobile information terminal 100 detects insertion of the SIM group into both of the first SIM connection section 171 and the second SIM connection section 172, or any of the first SIM connection section 171 and the second SIM connection section 172, and validates both of the SIM connection section 171 and the second SIM connection section 172 or any of the first SIM connection section 171 and the second SIM connection section 172 which the SIM group described above has been inserted. Further, the number of sheets of the SIM group having been inserted is confirmed (S502).

When the SIM group having been inserted is one sheet (S503: Yes), the SIM group having been inserted is set to the SIM group that is used in priority (main SIM) (S504). Meanwhile, when the SIM group having been inserted is not one sheet (S503: No), a SIM selection screen 180d is displayed on the touch screen 180 (the display section 131) (S505). In the SIM selection screen 180d, it is possible to select and set which of the SIM groups having been inserted in processing of S501 is made the SIM group that is used in priority (main SIM). The SIM group that was not selected is set as a SIM group not used in priority (sub-SIM). When the user executes selection of any of the SIM groups by touch operation to the touch screen 180 (the touch panel 123) (S506), the SIM group having been selected is set as the main SIM (S507).

FIG. 9C is a screen display drawing of an example of the SIM selection screen displayed in processing of the flowchart shown in FIG. 9A.

The SIM selection screen 180d is configured to include a SIM availability display region 180d1, a priority SIM setting region 180d2, and a SIM information display region 180d3. The SIM availability display region 180d1 displays the connection condition of the SIM group to the first SIM connection section 171 and the second SIM connection section 172 by “usable” or “non usable” or “not yet inserted” and the like. In the priority SIM setting region 180d2, it is possible to select which of the SIM groups inserted to the first SIM connection section 171 and the second SIM connection section 172 is to be made the main SIM. In the SIM information display region 180d3, information such as the telephone number determined and the name of the business operator of the mobile telephone communication network is displayed with respect to each of the SIM groups inserted to the first SIM connection section 171 and the second SIM connection section 172.

In the telephone call process (S510), processing of a procedure described below shown in FIG. 9B is executed.

In executing a telephone call, first, the user executes touch operation to a telephone icon displayed on a basic screen 180e, and selects the telephone call function (S511). Then, the telephone call section 1105 of the mobile information terminal 100 displays a telephone call function screen 180f on the touch screen 180 (S512). Next, the user selects the designation method of the transmission destination telephone number (S513). When the designation method of the transmission destination telephone number having been selected is “telephone directory” (S514: telephone directory), the process proceeds to processing of S515. When the designation method of the transmission destination telephone number having been selected is “direct input” (S514: direct input, the process proceeds to processing of S518.

In processing of S515, first, the user selects a “telephone directory” icon displayed on the telephone call function screen 180f. Then, the telephone call section 1105 reads the telephone directory of the user stored in the various information storage region 1019 and the like, and displays a telephone directory screen (illustration is omitted) on the touch screen 180 (S515). Next, the user selects the transmission destination by touch operation to the telephone directory screen having been displayed (S516). Then, the telephone call section 1105 displays the telephone number of the transmission destination having been selected by the user in a telephone number display region 180f3 of the telephone call function screen 180f (S517).

In processing of S518, the user directly inputs the telephone number of the transmission destination by touch operation to a numeric character key region 180f1 of the telephone call function screen 180f (S518). The telephone call section 1105 displays the touch-inputted numeric character to the telephone number display region 180f3 according to the touch operation of the user described above (S519). Processing of S518 to S519 is repeated by a portion of the number of digits of the telephone number.

After the designation process of the transmission destination telephone number by the user, the telephone call section 1105 confirms presence or absence of touch operation to a call origination key 180f4 of the telephone call function screen 180f (S520). When there is no touch operation (S521: No), the telephone call section 1105 stands by as it is. When there is touch operation (S521: Yes), a call origination process that is different according to the number of sheets of the SIM group inserted to the first SIM connection section 171 and the second SIM connection section 172 is executed.

When the SIM group having been inserted is one sheet (S522: Yes), the SIM group of one sheet having been inserted is set as the main SIM, and the sub-SIM does not exist. Therefore, the call origination process is executed based on information and the like recorded in the main SIM described above (S523).

When the SIM group having been inserted is not one sheet (S522: No), the telephone call section 1105 confirms whether or not there was contact of the finger of the user to the touch sensor 122 when touch operation to the call origination key 180f4 was executed in processing of S520 (S524). When there was no contact of the finger of the user to the touch sensor 122 (S525: No), a call origination process is executed based on information and the like recorded in the SIM group set as the main SIM in the initial setting process S500 (S523). When there was contact of the finger of the user to the touch sensor 122 (S525: Yes), a call origination process is executed based on information and the like recorded in the SIM group set as the sub-SIM in the initial setting process S500 (S526).

FIG. 9D is a screen display drawing of an example of the basic screen displayed in processing of the flowchart shown in FIG. 9B.

The basic screen 180e is configured to include a main function icon display region 180e1, a general icon display region 180e2, and an other information display region 180e3. The main function icon display region 180e1 is a display region of icons that are related to main applications frequently used in the mobile information terminal 100. A telephone icon is displayed in this region. The general icon display region 180e2 is a display region of icons that are related to other applications. The other information display region 180e3 is a region for displaying general information such as time clock information and weather information.

FIG. 9E is a screen display drawing of an example of the telephone call function screen displayed in processing of the flowchart shown in FIG. 9B.

The telephone call function screen 180f is configured to include the numeric character key region 180f1, a function menu region 180f2, the telephone number display region 180f3, and the call origination key 180f4. In the numeric character key region 180f1, characters such as the numeric characters, “*”, and “#” are displayed. By executing touch operation to the numeric character key region 180f1, direct inputting of the telephone number is enabled. In the function menu region 180f2, a menu for calling out the telephone directory screen, the outgoing call history screen, and the incoming call history screen is displayed. In the telephone number display region 180f3, the telephone number designated by direct inputting or by selection from the telephone directory is displayed. When the transmission destination is selected from the telephone directory, other information related to the telephone number having been selected (full name and the like) may also be displayed. The call origination key 180f4 is an icon for executing a call origination process. The call origination process is started triggered by touch operation to the call origination key 180f4.

In the mobile information terminal 100 of the present embodiment, it is enabled to easily select the SIM group to be used according to the contact state of the finger to the touch sensor 122 at the time of executing a telephone call. That is to say, it is enabled to execute a telephone call while switching the transmission origin telephone number (the own telephone number) by simple operation. In other words, usability of the mobile information terminal 100 improves.

### [Modification]

A confirming process of the contact state of the finger to the touch sensor 122 may be executed at the time of the touch operation to the call origination key 180f4 as explained above, or may be executed at the time of the selection process of the telephone call function, or may be executed at the time of the selection process of the transmission destination from the telephone directory, or may by executed at the time of direct inputting of the transmission destination telephone number. That is to say, such control may be executed that call origination process based on information and the like recorded in the SIM group set as the sub-SIM is executed when there is contact of the finger to the touch sensor 122 at any timing of the telethon call process S510, and that a call origination process based on information and the like recorded in the SIM group set as the main SIM is executed when there is no contact of the finger to the touch sensor 122.

Switching between the call origination process based on information and the like recorded in the SIM group set as the main SIM and the call origination process based on information and the like recorded in the SIM group set as the sub-SIM may be executed also at the time of a telephone call based on the outgoing call history and the incoming call history. In this case, a call origination process is executed by a telephone number different from the telephone number having been recorded in the outgoing call history and the incoming call history.

Also, the touch sensor 122 is made a fingerprint sensor, the SIM group for private use is set as the main SIM, and the SIM group for business use is set as the sub-SIM. In this case, a call origination process based on information and the like having been recorded in the SIM group for private use can be executed without necessitating contact of the finger to the touch sensor 122. Meanwhile, a call origination process based on information and the like having been recorded in the SIM group for business use can be executed necessitating contact of the finger to the touch sensor 122. At this time, since the touch sensor 122 has been made a fingerprint sensor, security of the call origination process based on information and the like having been recorded in the SIM group for business use can be improved.

Although examples of embodiments of the present invention were explained above using the first to fourth embodiments, it is needless to mention that the configuration that achieves the technology of the present invention is not limited to the embodiments described above, and various modifications are possible. For example, a part of a configuration of an embodiment can be replaced by a configuration of another embodiment, and a configuration of an embodiment can be added with a configuration of another embodiment. All of them belong to the scope of the present invention. Also, numerical values, messages and the like appearing in the text and the drawings are an example only, and the effect of the present invention is not impaired even when different ones are used.

A part or all of the functions and the like of the present invention described above may be achieved by hardware by designing with an integrated circuit for example and so on, or may be achieved by software by that a microprocessor unit and the like interprets and executes a program that achieves respective functions and the like. It is also possible to use hardware and software in combination. The software described above may be in a state of being stored beforehand in the ROM 103, the storage section 110, and the like of the mobile information terminal 100 at the time point of product shipment, or may be one acquired from various server devices and the like on the internet after product shipment. Also, the software described above may be provided by a memory card, an optical disk, and the like.

Further, with respect to the control line and the information line shown in the drawings, those considered to be necessary for explanation were shown, and it is not necessarily limited to show all control lines and information lines of the product. It can be considered that almost all configurations are connected to each other in fact.

Also, in explanation described above, the touch sensor may be replaced by a hardware button namely a button switch for example.

### REFERENCE SIGNS LIST

100 . . . Mobile information terminal
101 . . . Main control section
102 . . . System bus
103 . . . ROM
104 . . . RAM
110 . . . Storage section
120 . . . Operation input section
121 . . . Operation key
122 . . . Touch sensor
123 . . . Touch panel
130 . . . Image processing section
131 . . . Display section
132 . . . Image signal processing section
133 . . . First image input section
134 . . . Second image input section
140 . . . Audio processing section
150 . . . Sensor section
160 . . . Communication section
170 . . . Expansion interface section
171 . . . First SIM connection section
172 . . . Second SIM connection section
180 . . . Touch screen
1101 . . . Basic operation section
1102 . . . Lock control section
1103 . . . User authentication section
1104 . . . SIM control section
1105 . . . Telephone call section

1. A mobile information terminal, comprising:
a first input section;
a second input section that is provided at a different location from the first input section; and
a control section that executes a single process by using a first input signal inputted from the first input section and a second input signal inputted from the second input section.

2. The mobile information terminal according to claim 1, further comprising:
an input signal storage section that stores the first input signal,
wherein, when the second input signal is acquired at the time of acquisition of the first input signal, the control section records the first input signal in the input signal storage section according to order of acquisition.

3. The mobile information terminal according to claim 2, further comprising:
a body section that incorporates the control section,
wherein the first input section is provided in a first surface of the body section, and
the second input section is provided in a second surface of the body section, the second surface being different from the first surface.

4. The mobile information terminal according to claim 3, further comprising:
an authentication information storage section that stores user authentication information that is defined using at least one or more numeric characters or characters; and
a user authentication section that executes a user authentication process based on a result of comparison between numeric characters or characters included in the first input signal and the user authentication information,
wherein the user authentication section determines whether or not the number of numeric characters or characters stored in the input signal storage section is the same as the number of numeric characters or characters included in the user authentication information, and, when it is determined to be a same number, compares numeric characters or characters stored in the input signal storage section and the user authentication information.

5. The mobile information terminal according to claim 3, further comprising:
an authentication information storage section that stores user authentication information that is defined using at least one or more numeric characters or characters;
a user authentication section that executes a user authentication process based on a result of comparison between numeric characters or characters included in the first input signal and the user authentication information; and
a third input section that receives inputting of a start signal that starts a user authentication process by the user authentication section,
wherein, when the start signal is acquired, the user authentication section compares numeric characters or characters stored in the input signal storage section and the user authentication information.

6. The mobile information terminal according to claim 5, further comprising:
a display section that is arranged in one surface of the body section; and
a touch panel that is layered in the display section,
wherein the first input section is an input region for a numeric character string or a character string within the touch panel, and
the third input section is an input fixing button region within the touch panel.

7. The mobile information terminal according to claim 2, further comprising:
a fingerprint information storage section that stores fingerprint information of a user,
wherein the second input section is a touch sensor that reads fingerprint information of a user, and
the control section checks fingerprint information of a user read by the touch sensor with fingerprint information stored in the fingerprint information storage section, and, when both agree with each other, records the first input signal in the input signal storage section.

8. The mobile information terminal according to claim 3,
wherein the first input section is a hard button provided on the first surface.

9. A method for controlling a mobile information terminal that includes a first input section and a second input section that is provided at a different location from the first input section, the method comprising:
a step for acquiring a first input signal inputted from the first input section and a second input signal inputted from the second input section; and
a step for executing a single process based on the first input signal and the second input signal.

10. The method for controlling a mobile information terminal according to claim 9,
wherein the single process is a process for recording the first input signal in a storage region included in the mobile information terminal according to order of acquisition when the first input signal and the second input signal are acquired.

11. A mobile information terminal provided with a terminal lock function, comprising:
a touch screen that receives inputting of authentication information for releasing the terminal lock function;
a touch sensor; and
a control section,
wherein the control section executes control so that, if there is contact of a finger of a user to the touch sensor when the authentication information is inputted to the touch screen, the authentication information inputted is handled to be valid, and
the control section executes control so that, if there is no contact of a finger of a user to the touch sensor when the authentication information is inputted to the touch screen, the authentication information inputted is handled to be invalid.
